(19) United States
(12) Patent Application Publication
(10) Pub. No.: US 2011/0214289 A1
(43) Pub. Date: Sep. 8, 2011

(54) COMBINATION POWERED GROOMING DEVICE

(76) Inventors: Michael Maichel, Frankfurt (DE); Markus Schuessler, Koenigstein (DE); Ralf Klug, Eschborn (DE); Cirilo Javier Perez Lopez, Eschborn (DE); Terence Gordon Royle, Basingstoke (GB); Andreas Larscheid, Sulzbach (DE); Stefan Rehbein, Bad Soden (DE); Ulrich Fandrey, Wetzlar (DE); Juergen Behrendt, Niederbrechen (DE); Gerrit Roenneberg, Darmstadt (DE)

(21) Appl. No.: 13/079,532

(22) Filed: Apr. 4, 2011

Related U.S. Application Data
(63) Continuation of application No. PCT/US2010/101983, filed on Mar. 3, 2010.

(51) Int. Cl. B26B 19/00; B26B 15/00; B26B 11/00; B23P 19/04; B26B 19/38

(52) U.S. Cl. 30/29.5; 30/277.4; 30/34.1; 30/123; 29/428

(57) ABSTRACT

A combination powered grooming device comprising a handle and a grooming attachment. The handle has a longitudinal axis extending between an upper end and a lower end. The handle comprises a trimmer assembly disposed adjacent the upper end and the trimmer assembly includes at least one moving blade. The handle further comprises an electrical arrangement disposed therein. The electrical arrangement comprises a motor having a drive shaft and a drive mechanism coupled to the drive shaft and to the trimmer assembly. In a trimming mode, the drive mechanism translates movement of the drive shaft to the moving blade. The grooming attachment is adapted for mounting onto the upper end.

### CROSS REFERENCE TO RELATED APPLICATION

This application is a continuation application of prior copending International Application No. PCT/US2010/101983, filed Mar. 3, 2010, designating the United States.

### FIELD OF THE INVENTION

The invention relates to a combination powered grooming device.

### BACKGROUND OF THE INVENTION

Most consumers find that dealing with multiple grooming tools like a razor, scissors and an electric trimmer every time they want to change the look of their facial hair can be inconvenient. Moreover, traveling with all these different devices is cumbersome and takes up a lot of space. Thus, there is a need to provide a device which overcomes this practice of inconveniently handling multiple implements and combines a trimming device with the other grooming functionalities.

### SUMMARY OF THE INVENTION

In an aspect, the invention features, in general, a combination powered grooming device comprising a handle and a grooming attachment. The handle has a longitudinal axis extending between an upper end and a lower end. The handle comprises a trimmer assembly disposed adjacent the upper end and the trimmer assembly includes at least one moving blade. The handle further comprises an electrical arrangement disposed therein. The electrical arrangement comprises a motor having a drive shaft and a drive mechanism coupled to the drive shaft and to the trimmer assembly. In a trimming mode, the drive mechanism translates movement of the drive shaft to the moving blade. The grooming attachment is adapted for mounting onto the upper end.

In another aspect, the invention features, in general, a combination powered grooming device comprising a handle and a grooming attachment. The handle has a longitudinal axis extending between an upper end and a lower end. The handle comprises a trimmer assembly disposed adjacent the upper end and the trimmer assembly includes at least one moving blade. The handle further comprises an electrical arrangement disposed therein. The electrical arrangement comprises a motor having a drive shaft and a drive mechanism coupled to the drive shaft and to the trimmer assembly. In a trimming mode, the drive mechanism translates movement of the drive shaft to the moving blade. The grooming attachment is adapted for mounting onto the upper end. The grooming attachment comprises a razor assembly including a cartridge connecting structure connected to a razor cartridge having at least one elongated blade mounted therein.

In yet another aspect, the invention features, in general, a method of using a combination powered grooming device. The method comprises providing a handle having a longitudinal axis extending between an upper end and a lower end. The handle comprises a trimmer assembly disposed adjacent the upper end and the trimmer assembly includes at least one moving blade. The handle further comprises an electrical arrangement disposed therein. The electrical arrangement comprises a motor having a drive shaft and a drive mechanism coupled to the drive shaft and to the trimmer assembly. In a trimming mode, the drive mechanism translates movement of the drive shaft to the moving blade. The method further comprises attaching a grooming attachment onto the upper end.

Other features and advantages of the invention will be apparent from the description and drawings, and from the claims.

### BRIEF DESCRIPTION OF THE DRAWINGS

FIG. 1 is a perspective view of a combination powered grooming device of the present invention which includes a grooming attachment mounted on a handle;

FIG. 1A is a cross-sectional view along I-I of FIG. 1;

FIG. 1B is a perspective view of the device of FIG. 1 with the grooming attachment separated from the handle;

FIG. 2A is a cross-sectional view along II-II of the handle of FIG. 1B in a trimming mode;

FIG. 2B is a cross-sectional view along II-II of the handle of FIG. 1B in a grooming mode;

FIG. 3 shows a partial cross-sectional view of a combination powered grooming device of the present invention with a trimmer comb attached;

FIG. 4A shows a front view of an embodiment of a motor, eccentric weight, and counterweight of the grooming device of FIG. 1 in the grooming mode;

FIG. 4B shows a front view of the embodiment in FIG. 4A in the trimming mode;

FIG. 4C shows a top view of the embodiment of FIG. 4A;

FIG. 4D shows a top view of the embodiment of FIG. 4B;

FIG. 5A shows a front view of an embodiment of an electrical arrangement, a trimmer assembly, and a decoupling mechanism of the grooming device of FIG. 1 in a trimming mode;

FIG. 5B shows a front view of the embodiment of FIG. 5A in the grooming mode;

FIG. 6A a front view of another embodiment of an electrical arrangement, a trimmer assembly, and a decoupling mechanism of the grooming device of FIG. 1 in the trimming mode;

FIG. 6B shows a front view of the embodiment of FIG. 6A in the grooming mode;

FIG. 7 shows a partial cross-sectional view of an embodiment of a combination powered grooming device of the present invention with a razor assembly;

FIG. 8 shows a partial cross-sectional view of another embodiment of a combination powered grooming device of the present invention with a dry shaver assembly;

FIG. 9 shows a partial cross-sectional view of another embodiment of a combination powered grooming device of the present invention with a toothbrush assembly;

FIG. 10 shows a partial cross-sectional view of an alternative embodiment of a combination powered grooming device of the present invention with a nose hair assembly;

FIG. 11 shows a partial cross-sectional view of an additional embodiment of a combination powered grooming device with an exfoliator assembly;

FIG. 12A shows a perspective view of an embodiment of the electrical arrangement and trimmer assembly in the trimming mode;

FIG. 12B shows a perspective view of the embodiment of FIG. 12A in the grooming mode;

FIG. 13A shows a front view of another embodiment in the trimming mode;

FIG. 13B shows a front view of the embodiment of FIG. 13A in the grooming mode;

FIG. 14A shows a partial cross-sectional view of another embodiment in the trimming mode;

FIG. 14B shows a partial cross-sectional view of the embodiment of FIG. 14A in the grooming mode;

FIG. 15A shows a partial cross-sectional view of an embodiment in the trimming mode;

FIG. 15B shows a partial cross-sectional view of the embodiment of FIG. 15A in the grooming mode;

FIG. 16A shows a partial cross-sectional view of an embodiment in the trimming mode; and

FIG. 16B shows a partial cross-sectional view of the embodiment of FIG. 16A in the grooming mode.

### DETAILED DESCRIPTION OF THE INVENTION

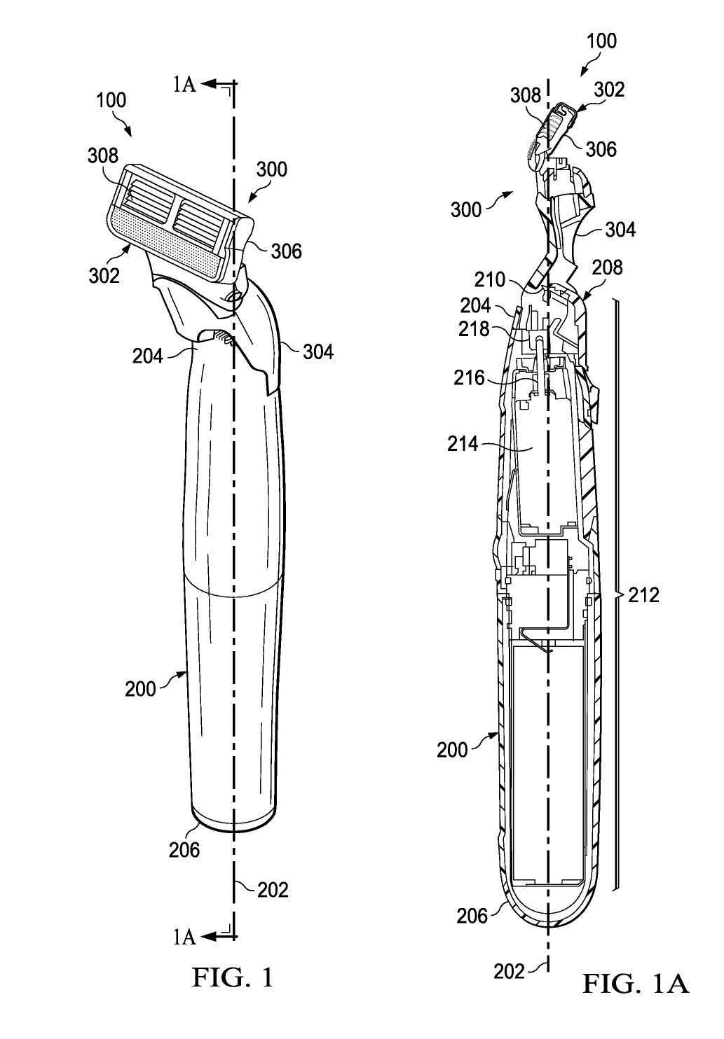

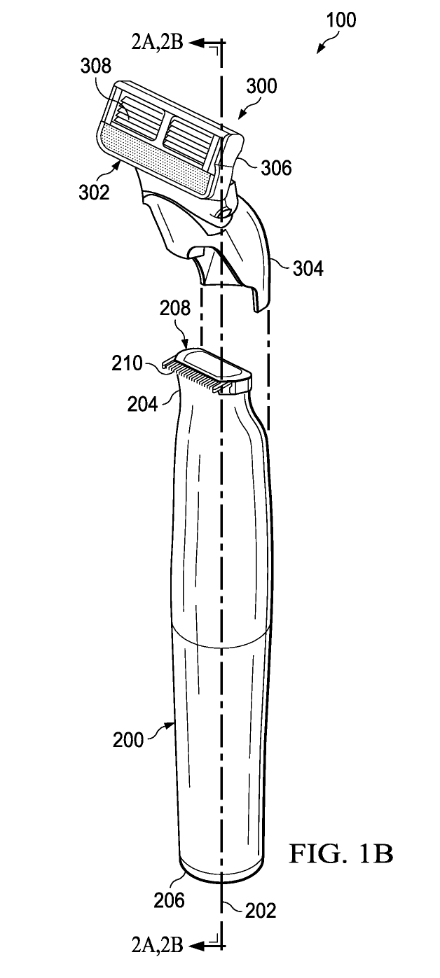

Referring to FIGS. 1-2B, the present disclosure shows a combination powered grooming device (100) that includes a handle (200) and a grooming attachment (300) mounted to the handle (200). FIG. 1A shows a cross-sectional view of the device of FIG. 1 taken along line I-I. The handle (200) has a longitudinal axis (202) that extends between an upper end (204) and a lower end (206). In an embodiment, the handle (200) may have a width of less than about 35 mm, or even less than about 27 mm. A trimmer assembly (208) is disposed adjacent the upper end (204) of the handle (200) and includes at least one moving blade (210). The handle (200) may be constructed to be held by a user during operation such that the internal components, i.e., an electrical arrangement (212), are impervious to liquids. The lower end (206) of the handle (200) may include a removably attached cap for accessing these components.

The electrical arrangement (212) is disposed in the handle (200) and is configured to supply power for operating the trimmer assembly (208). The electrical arrangement (212) includes a motor (214) and a drive mechanism (218). The motor (214) has a drive shaft (216) for driving the moving blade (210) and may also vibrate at least the handle (200). In an embodiment, the motor (214) has a diameter less than about 18 mm, a peak efficiency less than or equal to 55%, and an output torque less than about 0.8 mNm at peak efficiency.

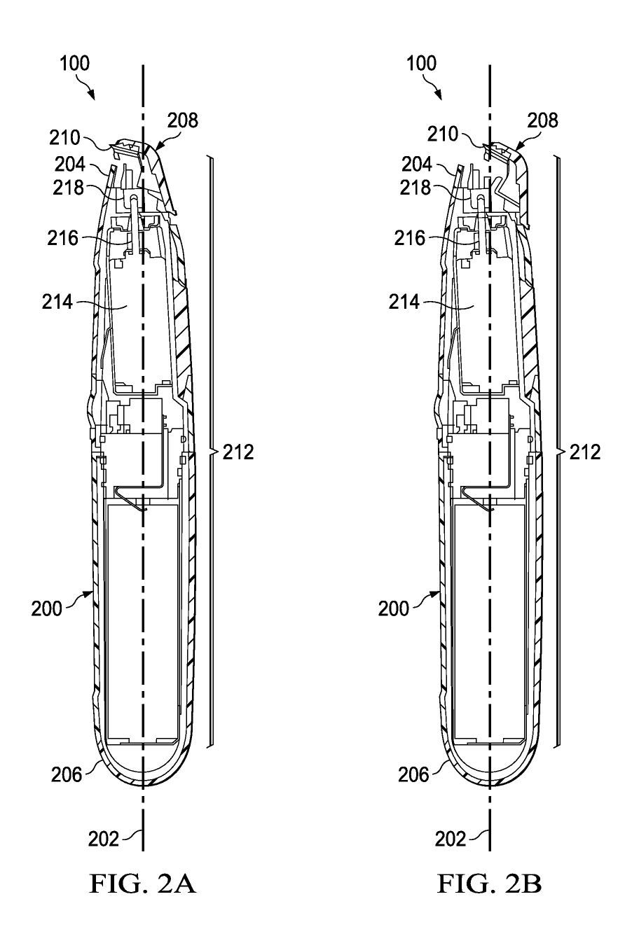

The drive mechanism (218) may be coupled to the drive shaft (216) and to the trimmer assembly (208). In a trimming mode, shown in FIG. 2A, the drive mechanism (218) is coupled to the trimmer assembly (208) and translates the rotational movement of the drive shaft (216) to lateral reciprocating movement of the moving blade (210). In the trimming mode, the trimmer assembly (208) functions as a powered trimmer that typically operates by reciprocally moving back and forth a moving blade (210). The moving blade typically (210) has a series of teeth that operate to cut hair in a scissoring fashion as the teeth of the moving blade (210) move past the teeth of the stationary teeth when the motor (214) is turned on. A trimmer comb (238) may be positioned over the trimmer assembly, as shown in FIG. 3, for trimming the hair to a desired length.

In a grooming mode, shown in FIG. 2B, the drive mechanism (218) is decoupled from the trimmer assembly (208) such that the drive shaft (216), with or without the drive mechanism (218) coupled, may rotate, but such movement is not translated to the moving blade (210). In this configuration, the motor (214) continues to operate, which vibrates at least the handle, but power is no longer supplied to the trimming assembly (208) thereby stopping the movement of the moving blade (210).

The electrical arrangement (212) may also include a power source, a controller, a printed circuit board (“PCB”), a switch, and a light operatively connected to the PCB. Various power sources, e.g., radiant, kinetic, potential, thermal, magnetic, gravitational, sound energy, light energy, electrical, electromagnetic, chemical source, and combinations thereof, may be used. The electrical arrangement (212) may also include an energy storage device, e.g., coin cell, double layer capacitor, solar cell, battery, or other suitable storage device. In an example, the energy storage can be configured to provide inductive charging via an external charging station. The handle (200) may include a switch disposed thereon such that the switch is in operative communication with the electrical arrangement (212). Additionally, the switch may be illuminated by a light source on the electrical arrangement (212).

As shown in FIGS. 1-1B, the grooming attachment (300) mounts onto the upper end (204) of the handle (200). This mounting can be accomplished by a snap-fit connection, an interference fit, or other suitable ways to secure the grooming attachment (300) to the handle (200). As shown, the grooming attachment (300) is a razor assembly (302) having a cartridge connecting structure (304) connected to a razor cartridge (306). The razor cartridge (306) includes at least one elongated blade (308) mounted therein. For example, U.S. Pat. No. 7,168,173 generally describes a Fusion® razor with multiple blades and a stationary trimming blade that is commercially available from The Gillette Company. Additionally, U.S. Pat. No. 6,185,823 describes a Venus® razor having an oval framed cartridge having multiple blades that is commercially available from the Gillette Company. The grooming attachment (300) may also include an ejection mechanism for removably attaching the razor cartridge (306) to the connecting structure (304).

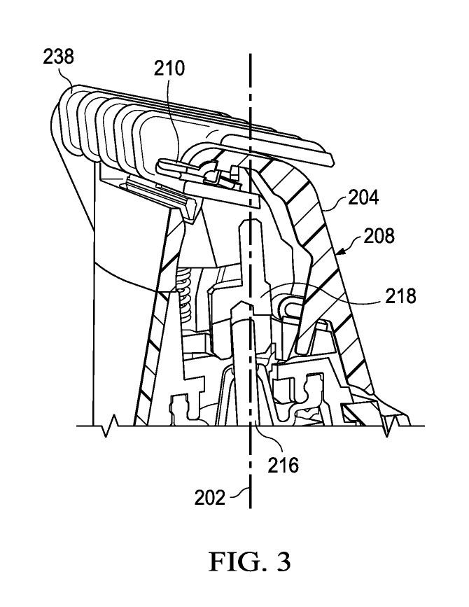

Referring to FIGS. 4A-4D, the drive shaft (216) may include an eccentric weight (220) mounted thereto. The eccentric weight (220) may vibrate at least the handle (200). Alternatively, the eccentric weight (220) may reduce the vibration about the trimmer assembly (208) by compensating for the movement of the moving blade (210). As shown, the eccentric weight (220) includes a crank lever (222) for driving the drive mechanism (218). In the trimming mode, the crank lever (222) translates the rotation of the drive shaft (216) to the drive mechanism (218) for operating the moving blade (210). In the grooming mode, the crank lever (222) is generally positioned above the drive shaft (216) and motor axis, so that the crank lever (222) rotates without cranking, i.e., the trimmer assembly (208) does not operate, but the handle (200) continues to vibrate.

A counterweight (224) may also be mounted to the drive shaft (216). In the trimming mode, shown in FIGS. 4B and 4D, the eccentric weight (220) and the counterweight (222) are at least substantially balanced so that the trimmer assembly (208) is driven by the crank lever (222). In the grooming mode, shown in FIGS. 4A and 4C, the eccentric weight (220) and the counterweight (222) are less than substantially balanced. Changing between the trimming mode and grooming mode can be done by changing the orientation of rotation of the motor (214). For example, a rotation in a clockwise direction causes the inertia moment of the eccentric weight (220) to fall into its balanced position. Rotation in a counterclockwise direction causes the inertia moment of the eccentric weight to move into its unbalanced position.

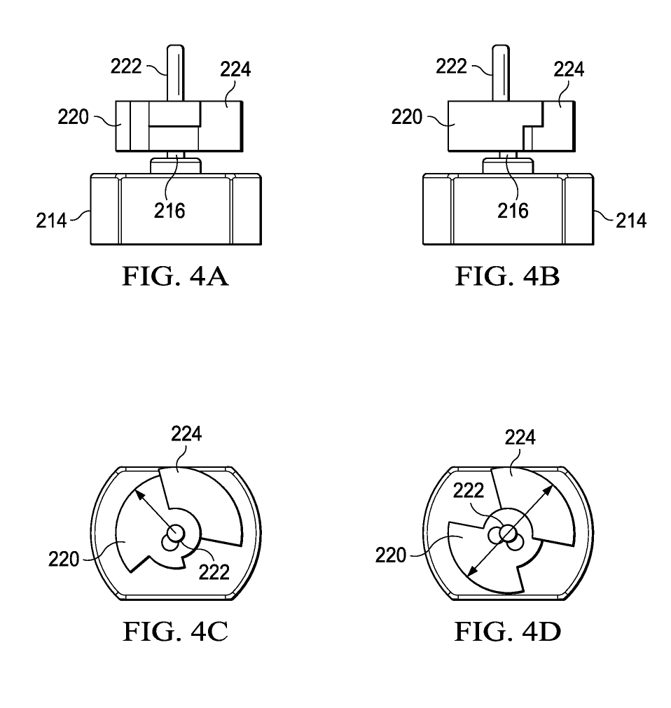

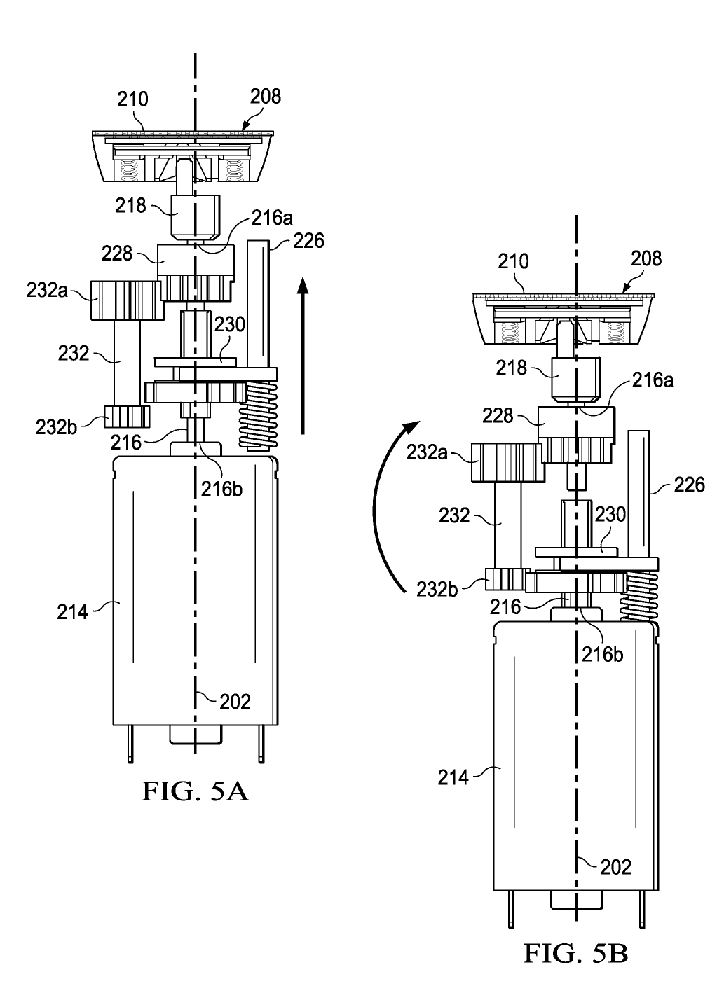

Referring to FIGS. 5A-6B, the handle (200) may include a decoupling mechanism (226) that is engageable by the grooming attachment (300). Engaging the decoupling mechanism (226) causes the drive mechanism (226) to decouple from either the trimmer assembly (208) and/or the entire drive shaft (216), thereby resulting in a grooming mode. For example, as depicted, the decoupling mechanism (226) is spring-loaded and movable in a direction generally parallel to the longitudinal axis (202). In the trimming mode, the decoupling mechanism (226) is in a rest position, shown in FIGS. 5A and 6A. Upon engagement with the grooming attachment (300), i.e., mounting the grooming attachment (300) over the trimmer assembly (208), the decoupling mechanism (226) is moved in a generally downward direction resulting in the grooming mode, shown in FIGS. 5B and 6B. Removing the grooming attachment (300) causes the spring to return the decoupling mechanism (226) back to the rest position. Other suitable ways, e.g., electrical or electromechanical, for decoupling the drive mechanism (226) from either the trimmer assembly (208) and/or the entire drive shaft (216) is also contemplated. Additionally, the drive shaft (216) may be separable into a top portion (216a) and bottom portion (216b).

Now referring to FIGS. 5A and 5B, the electrical arrangement (212) includes an eccentric weight (228) rotatably mounted to the top portion (216a) of the drive shaft (216), a first gear (230) mounted to the bottom portion (216b) of the drive shaft (216) and connected to the decoupling mechanism (226). The electrical arrangement (212) also includes a second gear (232), which has a top portion (232a) and a bottom portion (232b), positioned adjacent to the drive shaft (216). The eccentric weight (228) vibrates at least the handle (200) when the trimmer assembly (208) is in the grooming mode. In the trimming mode, as shown in FIG. 5A, rotation of the bottom portion (216b) is translated to the top portion (216a) and ultimately to the moving blade (208). However, in the trimming mode, the eccentric weight (228) does not rotate.

Engaging the decoupling mechanism (226) with the grooming attachment (300) causes a shift from the trimming mode, shown in FIG. 5A, to the grooming mode, shown in FIG. 5B. In the grooming mode, the top portion (216a) of the drive shaft (216) is separated from the bottom portion (216b) of the drive shaft (216), the bottom portion (232b) of the second gear (232) is engaged with the first gear (230) and the top portion (232a) of the second gear (232) is engaged with the eccentric weight (228). In this configuration, rotation of the first gear (230) is translated to the eccentric weight (228) by rotation of the second gear (232), thereby resulting in increased vibratory motion on at least the handle (200).

Referring to FIGS. 6A and 6B, the electrical arrangement (212) includes an eccentric weight (234) rotatably mounted to the bottom portion (216b) of the drive shaft (216). A movable device (236) is also mounted to the bottom portion (216b) of the drive shaft (216) adjacent to the eccentric weight (234). The eccentric weight (234) vibrates at least the handle (200) when the trimmer assembly (208) is in the grooming mode. In the trimming mode, as shown in FIG. 6A, the movable device (236) is slidably positioned along both the top (216a) and the bottom (216b) portions of the drive shaft (216) and is configured to translate the rotation of the bottom portion (216b) of the drive shaft (216) to the top portion (216a) of the drive shaft (216). In this configuration, the eccentric weight (234) does not rotate. Engaging the decoupling mechanism (226) with the grooming attachment (300), shown in FIG. 6B, causes a shift from the trimming mode to the grooming mode. In the grooming mode, the movable device (236) is slidably positioned along the bottom portion (216b) and engaged with the eccentric weight, thereby resulting in increased vibratory motion on at least the handle (200).

In addition, the device (100) may be arranged in a kit or package. The kit comprises the device of the present invention and an accessory selected from the group consisting of a cleaning brush, a trimmer comb, a cleaning solution, a cloth, a power cord, a battery, a cover, a razor cartridge, a lubricant, toothpaste, a fluid for applying to a user, and combinations thereof. Other suitable accessories are contemplated. Alternatively, the kit may comprise the device (100) and a grooming attachment selected from the group consisting of a razor assembly, a dry shaver assembly, a toothbrush assembly, a brush assembly, a nose hair trimmer assembly, an ear hair trimmer assembly, an exfoliator assembly, and combinations thereof.

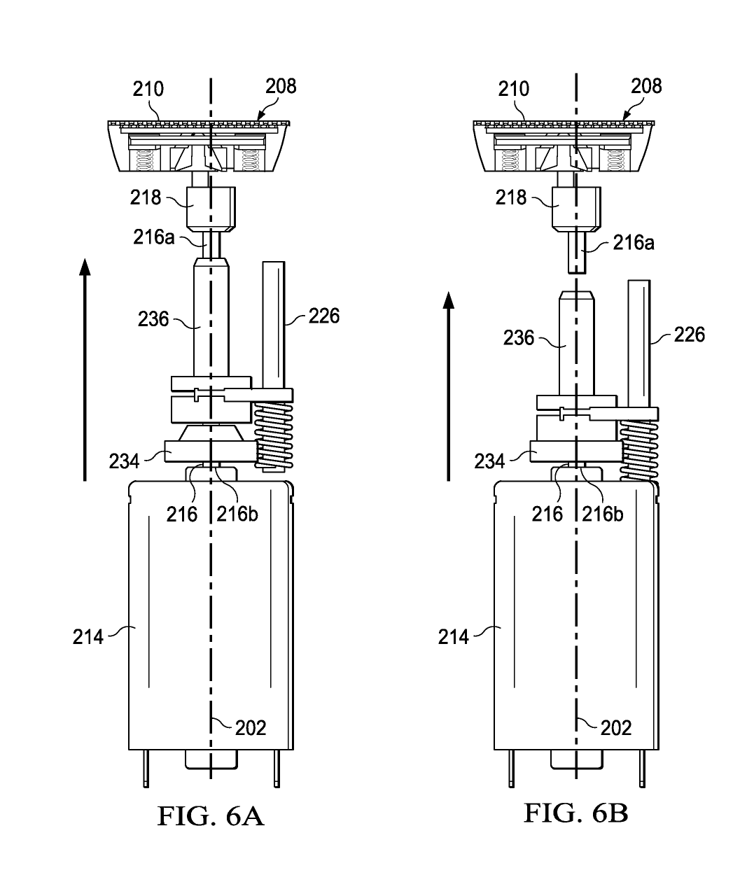

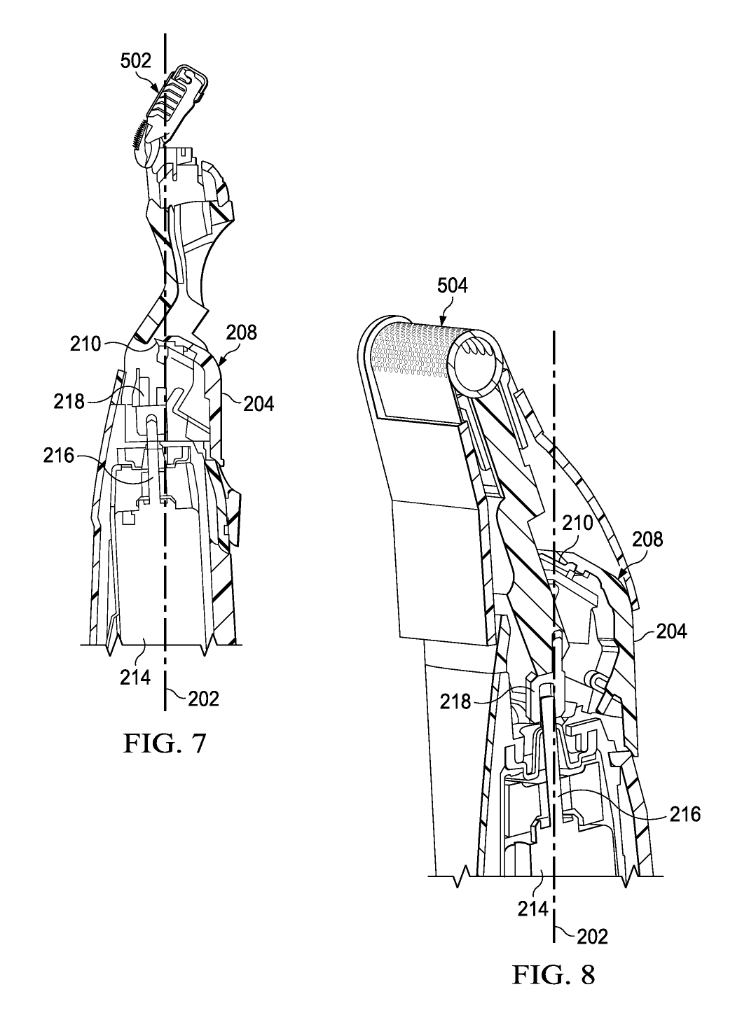

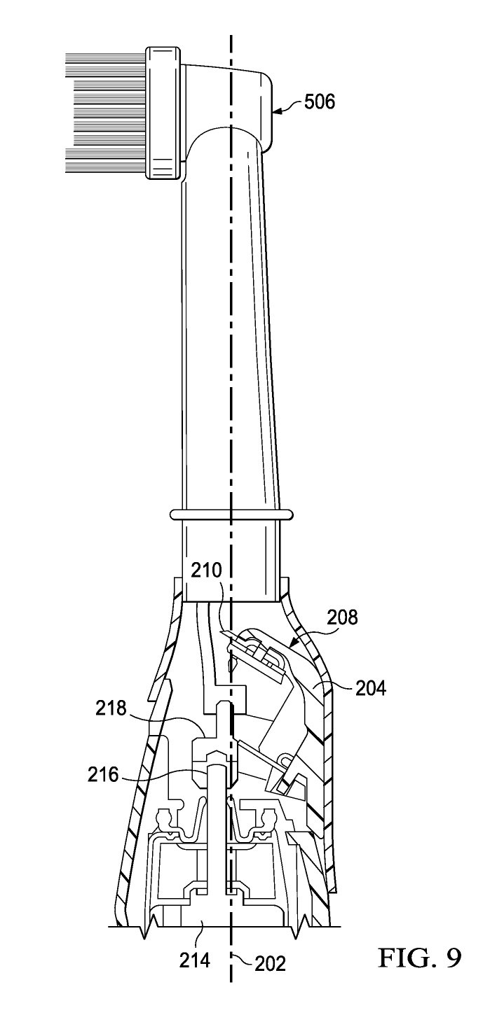

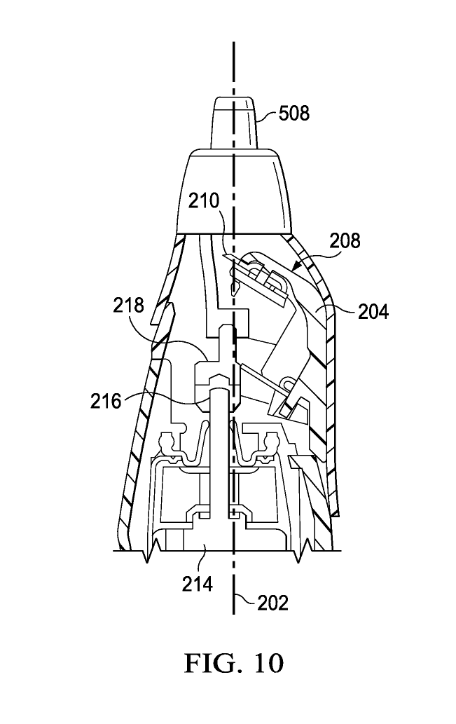

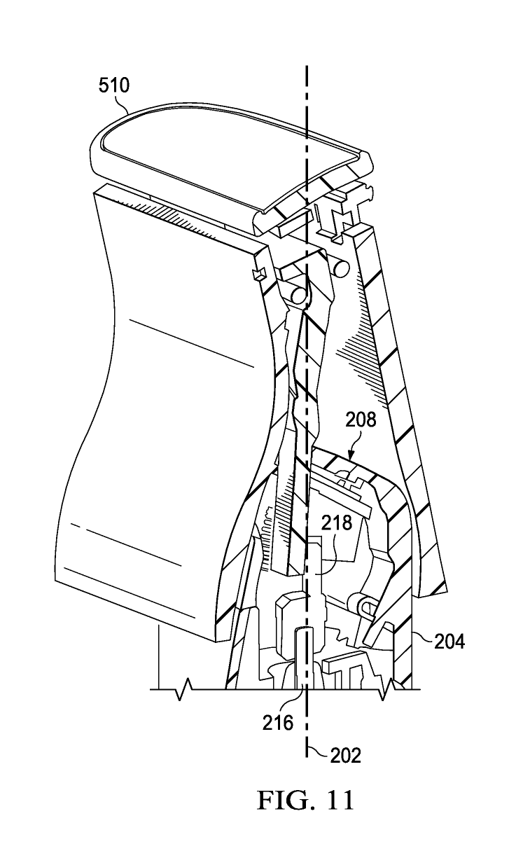

FIGS. 7-11 show other grooming attachments, e.g., a razor assembly (502), a dry shaver assembly (504), a toothbrush assembly (506), a nose hair trimmer assembly (508), an exfoliator assembly (510), and combinations thereof, that may be mounted onto the upper end (204). Other suitable grooming attachments may also be used. In some embodiments, the grooming attachment may be configured to couple with the drive mechanism (218) when the trimmer assembly (208) is in the grooming mode.

The present disclosure also features a method of using the combination powered grooming device. The method comprises providing a handle and attaching a grooming attachment onto the upper end. The handle has a longitudinal axis extending between an upper end and a lower end. The handle comprises a trimmer assembly disposed adjacent the upper end and the trimmer assembly having at least one moving blade. The handle has an electrical arrangement disposed therein. The electrical arrangement includes a motor having a drive shaft and a drive mechanism coupled to the drive shaft and to the trimmer assembly. In a trimming mode, the drive mechanism translates movement of the drive shaft to the moving blade.

The method may also include a subsequent step of decoupling the drive mechanism from the trimmer assembly or drive shaft which defines a grooming mode. The decoupling step may be performed in various ways, as shown in FIGS. 2A, 2B and 12A-16B. For example, the decoupling step (706) may be achieved by changing the rotation of the drive shaft from a forward direction to a reverse direction. Alternatively, the decoupling step (706) may be accomplished by moving the trimmer assembly in a direction generally transverse to the longitudinal axis, as shown in FIGS. 2A and 2B. FIG. 2A shows the trimmer assembly (208) in the trimming mode. Tilting the trimmer assembly (208) in a direction generally transverse to the longitudinal axis (202), shown in FIG. 2B, will decouple the drive mechanism (218) resulting in the grooming mode.

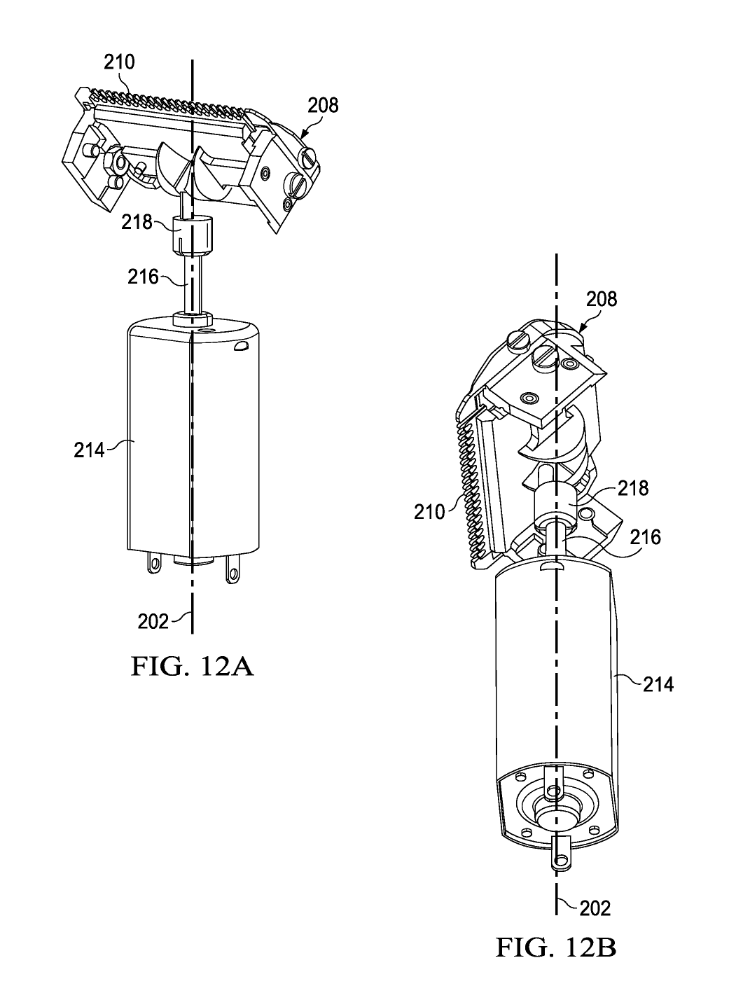

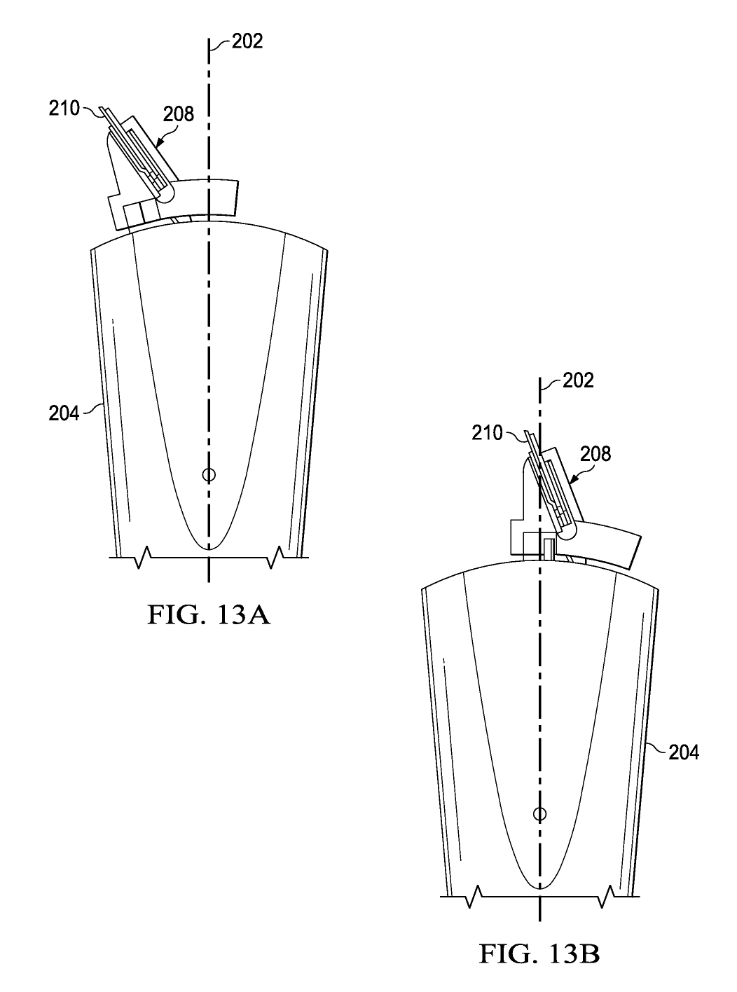

Referring to FIGS. 12A and 12B, the trimmer assembly (208) may be pivotable to provide for trimming at various angles. As shown, the trimmer assembly (208) is pivotable between a minimum and a maximum pivot angle. In the trimming mode, the trimmer assembly (208) is pivoted from the longitudinal axis (202) at an angle greater than about 15 degrees. In the grooming mode, the trimmer assembly (208) is positioned at an angle less than or equal to 15 degrees. Other angles are contemplated so long as the trimmer assembly (208) is decoupled in the grooming mode and operational in the trimming mode. Alternatively, FIG. 13A shows the trimmer assembly (208) in the trimming mode. The trimmer assembly (208) can be decoupled by sliding in a direction generally transverse to the longitudinal axis (202), shown in FIG. 13B.

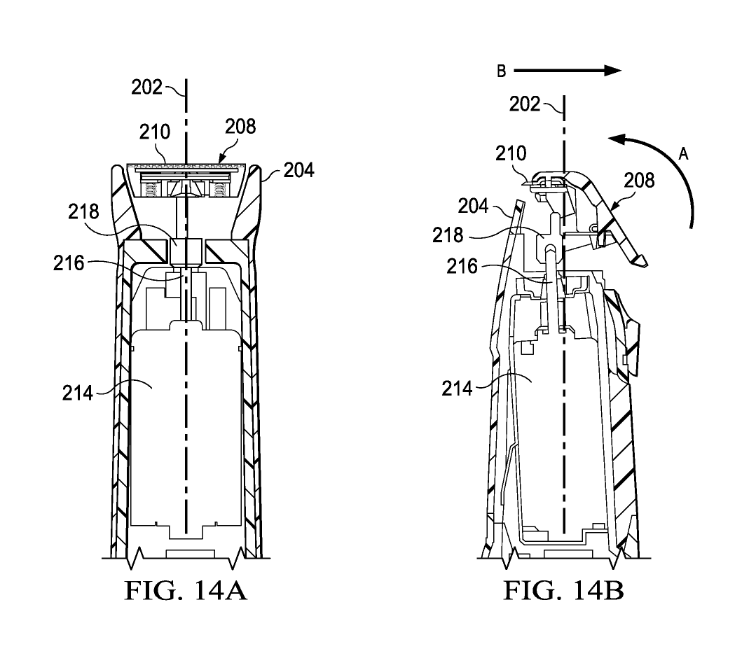

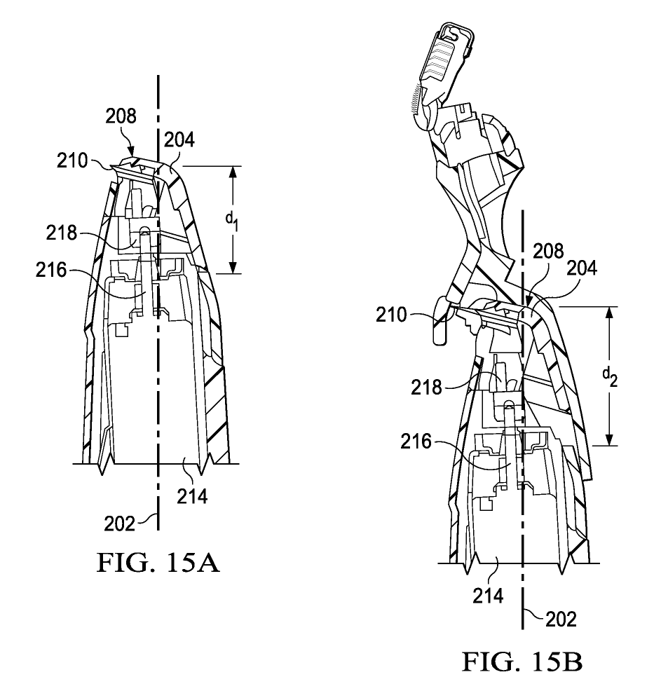

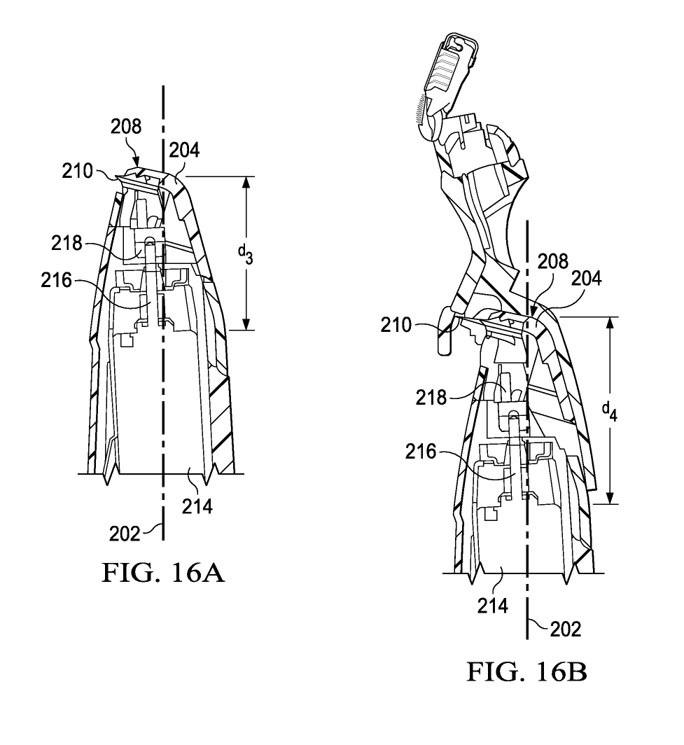

Referring to FIGS. 14A and 14B, the drive mechanism (218) may also be decoupled by rotating the trimmer assembly (208) about the longitudinal axis (202). Alternatively, as shown in FIGS. 15A and 15B, the trimmer assembly (208) may be moved in a direction generally parallel to the longitudinal axis (202) such that the distance (d₁) between the trimmer assembly (208) and the drive mechanism (216) in the trimming mode is less than the distance (d₂) of the trimmer assembly and the drive mechanism after decoupling. Now referring to FIGS. 16A and 16B, the motor (204) or any portion thereof may be moved in a direction generally parallel to the longitudinal axis (202) such that the distance (d₃) between the motor (214) and trimmer assembly (208) in the trimming mode is less than the distance (d₄) between the motor (214) and the trimmer assembly (208) after being decoupled.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A combination powered grooming device comprising:
a. a handle having a longitudinal axis extending between an upper end and a lower end, the handle comprising
1) a trimmer assembly disposed adjacent the upper end, the trimmer assembly comprising at least one moving blade,
2) an electrical arrangement disposed in the handle, the electrical arrangement comprising
a) a motor having a drive shaft, and
b) a drive mechanism coupled to the drive shaft and to the trimmer assembly,
wherein, in a trimming mode, the drive mechanism translates movement of the drive shaft to the moving blade; and
b. a grooming attachment adapted for mounting onto the upper end.

2. The grooming device of claim 1, further comprising an eccentric weight mounted on the drive shaft.

3. The grooming device of claim 2, further comprising a counterweight mounted to the drive shaft wherein, in the trimming mode, the weights are at least substantially balanced, and, in a grooming mode, the weights are less than substantially balanced.

4. The grooming device of claim 1, wherein the grooming attachment is selected from the group consisting of a razor assembly, a dry shaver assembly, a toothbrush assembly, a brush assembly, a nose hair trimmer assembly, an ear hair trimmer assembly, an exfoliator assembly, and combinations thereof.

5. The grooming device of claim 4, further comprising a decoupling mechanism engageable by the grooming attachment for decoupling the drive mechanism from either the trimmer assembly or the drive shaft, wherein decoupling the drive mechanism defines a grooming mode.

6. The grooming device of claim 5, wherein the grooming attachment is configured to couple with the drive mechanism in the grooming mode.

7. The grooming device of claim 5, wherein the drive shaft comprises a top portion separable from a bottom portion.

8. The grooming device of claim 7, wherein the electrical arrangement further comprises:
a. an eccentric weight rotatably mounted to the top portion of the drive shaft, which vibrates at least the handle when the trimmer assembly is in the grooming mode,
b. a first gear mounted to the bottom portion of the drive shaft and connected to the decoupling mechanism, and
c. a second gear positioned adjacent the drive shaft, the second gear comprising a top portion and a bottom portion,
wherein engaging the decoupling mechanism with the grooming attachment results in the grooming mode defined by the top portion of the drive shaft separated from the bottom portion of the drive shaft, the bottom portion of the second gear engaged with the first gear, and the top portion of the second gear engaged with the eccentric weight, whereby rotation of the first gear is translated to the eccentric weight by rotation of the second gear.

9. The grooming device of claim 7, wherein the electrical arrangement further comprises:
a. an eccentric weight rotatably mounted to the bottom portion of the drive shaft, which vibrates at least the handle when the trimmer assembly is in the grooming mode, and
b. a movable device mounted to the bottom portion of the drive shaft adjacent the eccentric weight,
wherein, in the trimming mode, the movable device is slidably positioned along both the top and the bottom portions and is configured to translate the rotation of the bottom portion to the top portion, and
wherein engaging the decoupling mechanism with the grooming attachment results in the grooming mode defined by the movable device being slidably positioned along the bottom portion and engaged with the eccentric weight.

10. A kit comprising the grooming device of claim 1 and an accessory selected from the group consisting of a cleaning brush, a trimmer comb, a cleaning solution, a cloth, a power cord, a battery, a cover, a plurality of razor cartridges, a razor cartridge dispenser, a lubricant, toothpaste, a fluid for applying to a user, a stand, a charging station, and combinations thereof.

11. A kit comprising the grooming device of claim 1 and a grooming attachment selected from the group consisting of a razor assembly, a dry shaver assembly, a toothbrush assembly, a brush assembly, a nose hair trimmer assembly, an ear hair trimmer assembly, an exfoliator assembly, and combinations thereof.

12. A combination powered grooming device comprising:
a. a handle having a longitudinal axis extending between an upper end and a lower end, the handle comprising
1) a trimmer assembly disposed adjacent the upper end, the trimmer assembly comprising at least one moving blade,
2) an electrical arrangement disposed in the handle, the electrical arrangement comprising
a) a motor having a drive shaft, and
b) a drive mechanism coupled to the drive shaft and to the trimmer assembly,
wherein, in a trimming mode, the drive mechanism translates movement of the drive shaft to the moving blade; and
b. a grooming attachment adapted for mounting onto the upper end, the grooming attachment comprising a razor assembly including a cartridge connecting structure connected to a razor cartridge, wherein the razor cartridge comprises at least one elongated blade mounted therein.

13. The grooming device of claim 12, wherein by decoupling the drive mechanism from either the trimmer assembly or the drive shaft defines a grooming mode and wherein the grooming attachment is configured to couple with the drive mechanism in the grooming mode.

14. A method of using a combination powered grooming device comprising:
a. providing a handle having a longitudinal axis extending between an upper end and a lower end, the handle comprising
1) a trimmer assembly disposed adjacent the upper end, the trimmer assembly comprising at least one moving blade,
2) an electrical arrangement disposed in the handle, the electrical arrangement comprising
a) a motor having a drive shaft, and
b) a drive mechanism coupled to the drive shaft and to the trimmer assembly,
wherein, in a trimming mode, the drive mechanism translates movement of the drive shaft to the moving blade; and
b. attaching a grooming attachment onto the upper end.

15. The method of claim 14, further comprising the step of (c) decoupling the drive mechanism from the trimmer assembly or the drive shaft.

16. The device of claim 15, wherein step (c) is by rotating the drive mechanism in a reverse direction.

17. The device of claim 15, wherein step (c) is by moving the trimmer assembly in a direction generally transverse to the longitudinal axis.

18. The device of claim 15, wherein step (c) is by rotating the trimmer assembly about the longitudinal axis.

19. The device of claim 15, wherein step (c) is by moving the trimmer assembly in a direction generally parallel to the longitudinal axis.

20. The device of claim 15, wherein step (c) is by moving the motor in a direction generally parallel to the longitudinal axis.
